(19) United States
(12) Patent Application Publication
(10) Pub. No.: US 2004/0234851 A1
(43) Pub. Date: Nov. 25, 2004

(54) Positive electrode for lithium secondary battery and lithium secondary battery comprising same

(75) Inventors: Jan-Dee Kim, Seoul (KR); Seok Kim, Suwon-city (KR); Su-Suk Choi, Osan-city (KR); Ji-Seong Han, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/845,192

(22) Filed: May 14, 2004

(30) Foreign Application Priority Data
May 22, 2003 (KR) 2003-32549

(51) Int. Cl. H01M 4/62; H01M 4/58; H01M 4/60

(52) U.S. Cl. 429/217; 429/218.1; 429/213

(57) ABSTRACT

A positive electrode of a lithium secondary battery includes a positive active material, an electrically conductive material, a binder, and a thickener including a nonionic cellulose-based compound. A lithium secondary battery may utilize the positive electrode described above.

### CROSS-REFERENCE TO RELATED APPLICATIONS

This application is based on application No. 2003-32549 filed in the Korean Industrial Property Office on May 22, 2003, the content of which is incorporated hereinto by reference.

### BACKGROUND OF THE INVENTION

1. Field of the Invention

The present invention relates to a positive electrode for a lithium secondary battery and a lithium secondary battery comprising the same, and more specifically, to a lithium secondary battery in which both the utilization ratio of a positive active material and the cycle life characteristics are improved.

2. Description of the Related Art

The remarkable development of smaller, lighter, and higher capability electronic devices and communication devices has led to an increase in the demand for improving the performance of secondary batteries for such devices.

As a lithium secondary battery, a lithium ion battery and a lithium sulfur battery are actively studied, and among them, the lithium sulfur battery becomes more attractive since it has a theoretical energy density of 2800 Wh/Kg (1675 mAh/g), which is remarkably higher than other battery systems. Further, since sulfur is a common resource, it is cheap, and it is also environmentally friendly. Accordingly, research into developing a lithium secondary battery using sulfur is rapidly increasing.

Elemental sulfur, which is typically called inorganic sulfur (S₈), has the highest theoretical capacity and is a powder. It may be utilized to provide a positive electrode having a high capacity (1675 mAh/g.sulfur) since an electrode plate fabricated from the sulfur provides a high density of active material.

Since the sulfur used in the lithium sulfur battery is a nonconductive material, a conductive material is further required to facilitate the transfer of electrons. The conductive material comprises, for example, carbon black, metal powder, and the like. To bind the obtained positive electrode mass to the current collector, it is of utmost importance to select a suitable binder. For efficiency, only a small amount of the binder should be required to provide a significant physical binding strength to the electrode, so that a positive electrode with a high energy density is provided. The binder is also required to be non-reactive with an electrolyte solution and to maintain a stable form within the battery operating temperature range.

U.S. Pat. Nos. 5,523,179 and 5,814,420 disclose polyethylene oxide as an ionic conductive material, even though it is not stated as a binder. The polyethylene oxide acts as an ion channel due to its high ionic conductivity, as well as a binder, upon fabricating the battery. However, when the positive electrode is fabricated with only polyethylene oxide, the energy density is ultimately reduced since a substantial amount of polyethylene oxide is required to maintain properties of the electrode plate. Further, the polyethylene oxide has a melting point of between 60-70° C., so if the battery is exposed to a temperature above this melting point, the physical shape of the electrode plate is deformed such that applicable shapes of batteries made therewith are limited.

### SUMMARY OF THE INVENTION

It is an aspect of the present invention to provide a positive electrode for a lithium secondary battery including a binder having an improved binding strength so that the lithium secondary battery has a high energy density.

It is a further aspect of the present invention to provide a lithium secondary battery including the aforementioned positive electrode.

To accomplish these aspects, the present invention provides a positive electrode for a lithium secondary battery, including an active material for the positive electrode, an electrically conductive material, a binder, and a thickener comprising a nonionic cellulose-based compound.

The present invention also provides a lithium secondary battery including the aforementioned positive electrode, a negative electrode including a negative active material, and an electrolyte.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic drawing showing a structure of a lithium sulfur battery according to the present invention;

FIG. 2 is a graph illustrating a utilization rate of sulfur on the lithium sulfur battery according to Examples 1 to 3 and Reference Example 1;

FIG. 3 is a graph illustrating cycle-life characteristics of the lithium sulfur battery according to Examples 1 to 3 and Reference Example 1;

FIG. 4A is a photograph of films fabricated from thickeners used in Examples 1 to 3 and Reference Example 1; and

FIG. 4B is a photograph showing color changes after allowing the films of FIG. 4A to stand in a polysulfide solution for two weeks.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention relates to a positive electrode to improve both a utilization rate of a positive active material and cycle-life characteristics by increasing a viscosity of a binder to improve its binding strength. The positive electrode for the lithium secondary battery is applicable to all lithium batteries such as a lithium ion battery or a lithium sulfur battery, but it is more generally used in a lithium sulfur battery. Accordingly, hereinafter, the present invention will be explained with reference to a lithium sulfur battery.

Preferably, a nonionic cellulose-based compound used to increase viscosity in the present invention is a compound represented by the following Formula 1:

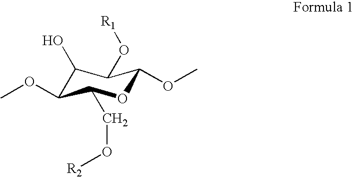

wherein R₁ and R₂ are independently H, a C₁ to C₁₀ alkyl group, or a hydroxy alkyl group.

More particularly, the nonionic cellulose-based compound includes methyl cellulose, hydroxypropyl cellulose, hydroxypropyl methyl cellulose, hydroxyethyl cellulose, hydroxypropyl ethyl cellulose, and a mixture thereof.

A thickener including the nonionic cellulose-based compound further increases the binding strength of the binder, thus allowing the amount of binder added to be reduced, and facilitates the coating of a positive active material composition on a current collector in a desired thickness. Further, although both ionic and nonionic cellulose-based compounds may exhibit the thickening effect, the nonionic cellulose is preferable since it increases the utilization rate of sulfur and improves the cycle-life characteristics compared to ionic cellulose. If ionic cellulose is employed, it may potentially react with the polysulfide formed upon the charge-discharge process, thus reducing the amount of active material to be reacted and lowering the utilization rate of the active material compared to the case of employing the nonionic cellulose-based compound. Further, the cycle-life is decreased when the structure of the positive electrode is destabilized upon carrying out the charge and discharge process and generating the concentrated reaction.

The amount of thickener, including a nonionic cellulose compound, is presented within the range of approximately 0.1 to 10% by weight based on the total weight of a mixture of a positive active material, a conductive material, a binder, and a thickener (hereinafter referred to as “positive electrode mass”). If the amount of the thickener is less than 0.1% by weight, the viscosity of the positive active material composition becomes too low to coat the composition on the current collector, and if the amount of the thickener is more than 10% by weight, the amount of the active material is relatively reduced in the positive electrode mass so that the battery capacity is reduced.

The positive electrode, according to the present invention, includes a positive active material, an electrically conductive material, and a binder, together with said thickener.

The binder acts to bind the positive active material composition with the current collector upon the fabrication of a positive electrode when a positive active composition slurry that includes the positive active material, the conductive material, the binder, and the thickener according to the present invention is coated on the current collector and dried. In addition, since the positive active material of elemental sulfur or a sulfur-based compound is a non-conductor, the transfer of electrons caused by the electrochemical reaction completely depends on the conductive material. Accordingly, the binder constitutes the conductive network between the sulfur and the conductive material. The binder also maintains physical strength in the electrode plate, fails to react with the electrolyte, and maintains a stable form within the range of the battery operating temperature.

Polyethylene oxide is generally used as the conventional binder satisfying such properties. However, since at least approximately 20% by weight of polyethylene oxide should be added to maintain such physical properties, the amount of positive active material is reduced correspondingly in the positive electrode due to increasing the binder amount, thus decreasing the energy density.

To solve the problems, the present invention provides a binder having a strong binding strength, which enables a reduction in the amount of binder.

The binder may be selected from polyvinylidene fluoride, a copolymer of polyvinylidene fluoride and hexafluoropropylene, acrylonitrile-butadiene rubber, styrene-butadiene rubber, sulfonated styrene/ethylene-butadiene/styrene triblock copolymer, or a mixture thereof. Among the above-cited materials, a styrene-based material such as styrene-butadiene rubber or a sulfonated styrene/ethylene-butadiene/styrene triblock copolymer is more preferable due to having a superior binding strength.

In the positive electrode according to the present invention, the mixed amount of the binder and the thickener is preferably presented at approximately 0.5 to 30% by weight, and more preferably at 0.5 to 20% by weight based on the total weight of above positive electrode mass. That is, the mixed amount of the binder and the thickener may be reduced to 0.5% by weight, thus allowing the relative amount of positive active material to be increased and increasing the battery capacity. However, if the mixed amount of the binder and the thickener is less than 0.5% by weight, a difficulty arises in that the amount of the binder and the thickener is insufficient to provide an electrode with sufficient physical properties, so that the active material may become detached from the conductive material in the electrode plate. On the other hand, if the amount of the binder and the thickener is more than 30% by weight, it is not desirable in that the ratio of active material and the conductive material in the positive electrode is cporrespondingly reduced so that the battery capacity becomes reduced. The mixing ratio of the binder and the thickener may be appropriately adjusted within the range required to obtain the effects of the present invention, which is understood by one having ordinary skill in the art.

The positive active material included in the positive electrode may include elemental sulfur (S₈), Li₂Sₙ(n≧1), an organic sulfur compound, or a carbon-sulfur polymer {(C₂Sₓ)ₙ, wherein x=2.5-50, n ≧2}. The electrically conductive material may further include an electrically conductive material that facilitates the movement of electrons within the positive electrode plate. The conductive material may include, but is not limited to, a carbon-based material such as carbon (e.g.: trade name: SUPER-P), carbon black, acetylene black, and furnace black; a conductive material such as a metal powder of Ni, Co, Cu, Pt, Ag, Au, or an alloy thereof; or a conductive polymer such as polyaniline, polythiophene, polyacetylene, polypyrrole, or a mixture thereof.

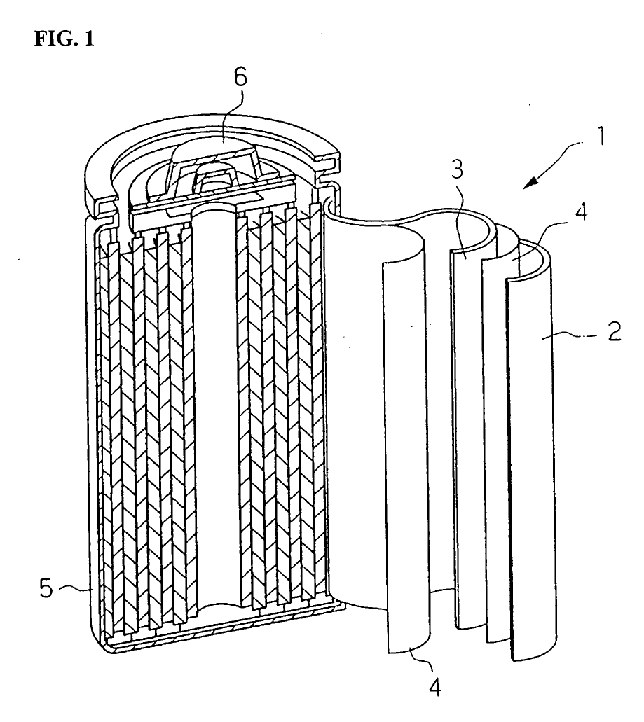

The lithium secondary battery including the positive electrode according to the present invention further includes a negative electrode and an electrolyte. The representative embodiment of the lithium secondary battery according to the present invention is shown in FIG. 1. The battery includes a positive electrode 3, a negative electrode 2, a separator 4 interposed between the positive electrode 3 and the negative electrode 2, and an electrolyte between the positive electrode 3 and the negative electrode 2. The battery further includes a battery case 5 and a sealing portion 6 sealing the battery case 5. The configuration of the rechargeable lithium battery is not limited to the structure shown in FIG. 1, as it can be readily modified into a prismatic, cylindrical, or pouch type battery as is well- understood in the related art.

The negative active material of the negative electrode includes a material that reversibly intercalates or deintercalates lithium ions, a material that reversibly forms a lithium-included compound by reacting with lithium ions, a lithium metal, and a lithium alloy.

The material that reversibly intercalates/deintercalates lithium ions may include any conventional carbonaceous negative active material generally used in the lithium ion secondary battery, such as crystal carbon, amorphous carbon, or a mixture thereof. Also, the material that reversibly forms a lithium-included compound by reacting with lithium ions may include, but is not limited to, tin oxide (SnO₂), titanium nitrate, and silicon (Si). The lithium alloy may include lithium alloyed with any metal selected from Na, K, Rb, Cs, Fr, Be, Mg, Ca, Sr, Ba, Ra, Al, or Sn.

The negative electrode may include a material in which an inorganic protection layer, an organic protection layer, or both are deposited on the surface of lithium metal. The inorganic protection layer may include any material selected from Mg, Al, B, C, Sn, Pb, Cd, Si, In, Ga, lithium silicate, lithium borate, lithium phosphate, lithium phosphoronitride, lithium silicosulfide, lithium borosulfide, lithium aluminosulfide, or lithium phosphosulfide. The organic protection layer may include a monomer, an oligomer, or a polymer having conductivity, and may be selected from poly(p-phenylene), polyacetylene, poly(p-phenylene vinylene), polyaniline, polypyrrole, polythiophene, poly(2,5-ethylene vinylene), acetylene, poly(peri-naphthalene), polyacene, and poly(naphthalene-2,6-diyl).

Further, during charging and discharging the lithium secondary battery, the sulfur of the positive active material is shifted to the inert material and is deposited on the surface of the lithium negative electrode. Such inactive sulfur is required since it is incapable of taking part in further electrochemical reactions as a result of repeated electrochemical and chemical reactions. In addition, the inactive sulfur deposited on the surface of the lithium negative electrode has an advantage of acting as a protection layer of the lithium negative electrode. Accordingly, the negative electrode may be formed with, for example, lithium sulfide comprising lithium metal and the inactive sulfur formed on the lithium metal.

The electrolyte may include an electrolyte salt and an organic solvent.

The organic solvent may be a single organic solvent or a mixed organic solvent including at least two groups selected from a weak polar solvent group, a strong polar solvent group, and a lithium metal protection group. Some electrolytes include at least one or more solvents selected from the same group.

The term “weak polar solvent,” as used herein, refers to a solvent which dissolves elemental sulfur and has a dielectric coefficient of less than 15. The weak polar solvent is selected from aryl compounds, bicyclic ether compounds, and acyclic carbonate compounds. The term “strong polar solvent,” as used herein, refers to a solvent which dissolves lithium polysulfide and has a dielectric coefficient of more than 15. The strong polar solvent is selected from acyclic carbonate compounds, sulfoxide compounds, lactone compounds, ketone compounds, ester compounds, sulfate compounds, and sulfite compounds. The term “lithium protection solvent,” as used herein, refers to a solvent which forms a stable solid-electrolyte interface (SEI) film on lithium metal, and shows a good cyclic efficiency of more than 50%. The lithium protection solvent is selected from saturated ether compounds, unsaturated ether compounds, and heterocyclic compounds including N, O, S, or a combination thereof.

The specific example of the weak polar solvent may include, but is not limited to, xylene, dimethoxy ethane, 2-methyl tetrahydrofuran, diethyl carbonate, dimethyl carbonate, toluene, dimethyl ether, diethyl ether, diglyme, tetraglyme, and the like.

The specific example of the strong polar solvent may include, but is not limited to, hexamethyl phosphoric triamide, γ-butyrolactone, acetonitrile, ethylene carbonate, propylene carbonate, N-methyl pyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, or ethylene glycol sulfite.

The specific example of the lithium protection solvent may include, but is not limited to, tetrahydrofuran, dioxolane, 3.5-dimethyl isoxazole, 2,5-dimethyl furan, furan, 2-methyl furan, 1,4-oxane, 4-methyl dioxolane and the like.

The lithium salt of the electrolyte salt may include, but is not limited to, lithium trifluoromethane sulfonimide, lithium triflate, lithium perchlorate, LiPF₆, LiBF₄, or a tetra alkyl ammonium such as tetrabutylammonium tetrafluoroborate, or a salt of imidazolium which is in a liquid state at a room temperature, such as 1-ethyl-3-methyl imidazolium bis-(perfluoroethyl sulfonyl) imide.

Hereinafter, the present invention will be explained in detail with reference to examples. These examples, however, should not in any sense be interpreted as limiting the scope of the present invention.

### COMPARATIVE EXAMPLE 1

Elemental sulfur (S₈), a conductive material of carbon black, and a binder of polyethylene oxide were added in a weight ratio of 6:2:2 to a acetonitrile solvent to prepare a positive active material slurry. The positive active material slurry was coated on a carbon coated Al current collector (REXAM INC.). Then, the slurry-coated current collector was dried to provide a positive electrode.

Using the obtained positive electrode and a negative electrode of a lithium foil, a lithium sulfur cell was fabricated in a conventional manner.

### COMPARATIVE EXAMPLE 2

A positive active material of elemental sulfur (S₈), a conductive material of carbon black, and a binder of styrene butadiene rubber were mixed in a weight ratio of 7:2:1 and dispersed in a mixed solvent of isopropyl alcohol and water (1:9 volume ratio). The obtained mixture was not viscous, so it could not be coated on the current collector.

### REFERENCE EXAMPLE 1

A positive active material of elemental sulfur (S₈), a conductive material of carbon black, a binder of styrene butadiene rubber, and a thickener of carboxyl methyl cellulose were mixed in a weight ratio of 7:2:0.3:0.7 and dispersed in a mixed solvent of isopropyl alcohol and water (1:9 volume ratio) to obtain a positive active material slurry.

The positive active material slurry was coated on a carbon coated Al current collector (REXAM INC.) to obtain a positive electrode mass density of 2 mAh/cm². Using the obtained positive electrode and a negative electrode of a lithium foil, a lithium sulfur cell was fabricated in a conventional manner.

Lithium sulfur cells fabricated from the methods of Comparative Example 1 and Reference Example 1 were charged and discharged at 0.1 C, 0.2 C, 0.5 C, and 1 C, the discharge capacity at each charge and discharge rate was measured, and the results are shown in the following Table 1.

TABLE 1

| | 0.1 C | 0.2 C | 0.5 C | 1 C |
|---|---|---|---|---|
| | discharge | discharge | discharge | discharge |
| | (mAh/mass | (mAh/mass | (mAh/mass | (mAh/mass |
| | weight) | weight) | weight) | weight) |
| Comparative | 793 | 603 | 552 | 459 |
| Example 1 | | | | |
| Reference | 981 | 739 | 672 | 551 |
| Example 1 | | | | |

As shown in Table 1, the discharge capacity in the battery of Reference Example 1 that included a binder of styrene butadiene rubber and a thickener of carboxyl methyl cellulose, was higher by more than 20% than the discharge capacity of the battery of Comparative Example 1 that included a binder of polyethylene oxide.

### EXAMPLE 1

A positive active material of elemental sulfur (S₈), a conductive material of carbon black, a binder of styrene butadiene rubber, and a thickener of hydroxy propyl methyl cellulose were mixed in a weight ratio of 7:2:0.3:0.7 and dispersed in a mixed solvent of isopropyl alcohol and water (1:9 volume ratio) to obtain a positive active material slurry.

The positive active material slurry was coated on a carbon-coated Al current collector (REXAM INC.) to obtain a positive electrode mass density of 2 mAh/cm². Using the obtained positive electrode and a negative electrode of a lithium foil, a lithium sulfur cell was fabricated in a conventional manner.

### EXAMPLE 2

A cell was fabricated by the same procedure as described in Example 1, except that the thickener was methyl cellulose.

### EXAMPLE 3

A cell was fabricated by the same procedure as described in Example 1, except that the thickener was hydroxypropyl cellulose.

Utilization Ratio of Sulfur

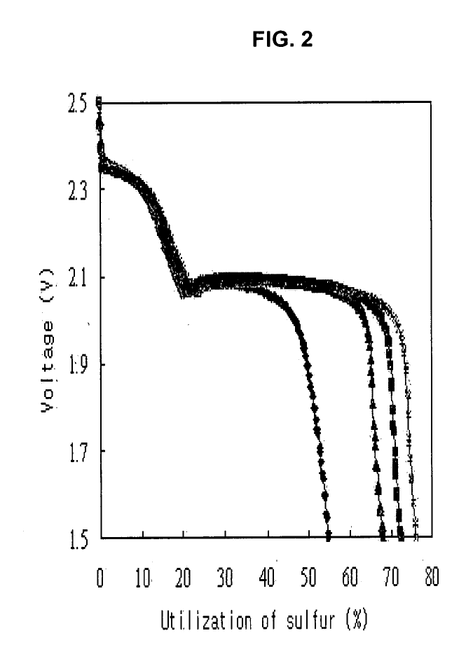

Lithium sulfur cells of Examples 1 to 3 and Reference Example 1 were measured for the utilization ratio of sulfur, and the results are shown in FIG. 2. As shown in FIG. 2, the cells of Examples 1 to 3 had improved utilization ratios of 15%, 20%, and 25%, respectively, compared to the cell of Reference Example 1.

Cycle-life Characteristics

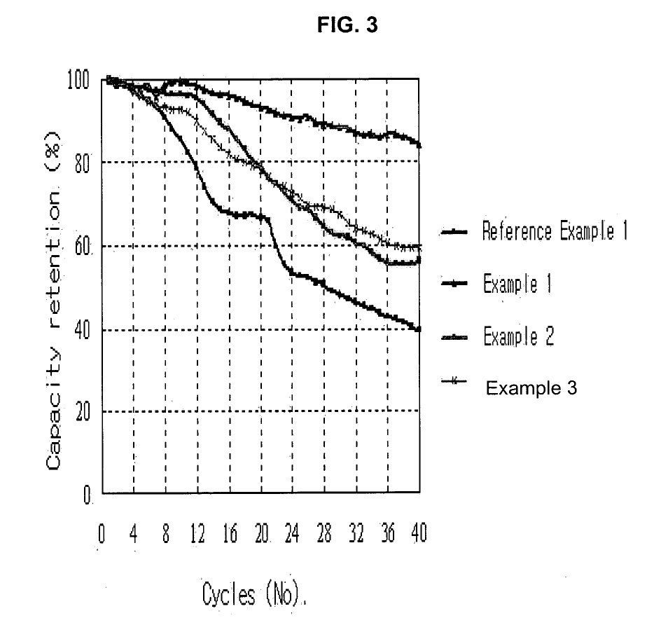

Lithium sulfur cells of Examples 1 to 3 and Reference Example 1 were measured for cycle-life characteristics, and the results are shown in FIG. 3. As shown in FIG. 3, the cells of Examples 1 to 3 had improved cycle-life characteristics of 40%, 20%, and 20% respectively, compared to the cell of Reference Example 1.

Test of Polysulfide Stability

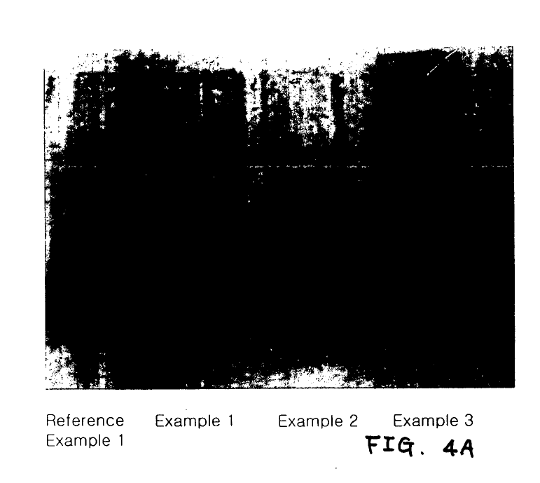

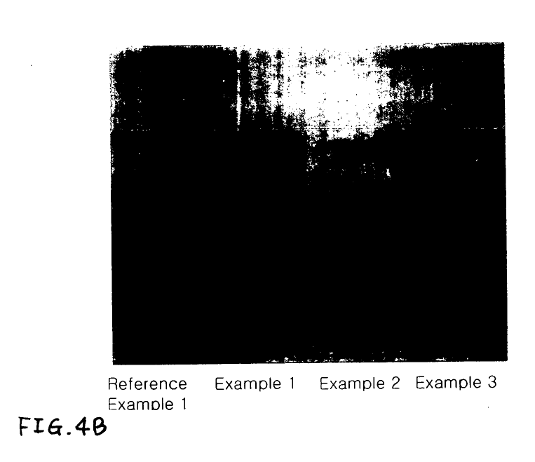

Each thickener used in Examples 1 to 3 and Reference Example 1 was formed into a film, as shown in FIG. 4A, and placed in a polysulfide solution. The films were left in the solution for two weeks, and the color change of the film was then measured. The results are shown in FIG. 4B. The degree of color change (lightening) increased in the order of Example 1, 2, 3, and Reference Example 1. From the results, it was determined that the thickener of Reference Example 1 actively reacted with the polysulfide solution, and thus the polysulfide became unstable.

As explained above, the positive electrode of the present invention may reduce the amount of binder and increase the amount of active material by employing a thickener of a nonionic cellulose-based compound and a binder having an effective binding strength, thus increasing the energy density of a positive electrode by more than 20%.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A positive electrode of a lithium secondary battery, comprising:
a positive active material;
an electrically conductive material;
a binder; and
a thickener comprising a nonionic cellulose-based compound.

2. The positive electrode according to claim 1, wherein the nonionic cellulose-based compound is a cellulose polymer represented by the following Formula 1: 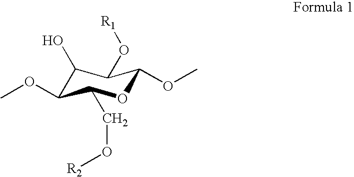
wherein R₁ and R₂ are independently H, a C₁ to C₁₀ alkyl group, or a hydroxy alkyl group.

3. The positive electrode according to claim 1, wherein the nonionic cellulose-based compound is selected from the group consisting of methyl cellulose, hydroxypropyl cellulose, hydroxypropyl methyl cellulose, hydroxyethyl cellulose, and hydroxypropyl ethyl cellulose.

4. The positive electrode according to claim 1, wherein the nonionic cellulose-based compound is added in an amount of approximately 0.1 to 10% by weight based on a total weight of the positive active material, the conductive material, the binder, and the thickener.

5. The positive electrode according to claim 1, wherein the binder is selected from the group consisting of polyvinylidene fluoride, a copolymer of polyvinylidene fluoride and hexafluoropropylene, acrylonitrile-butadiene rubber, styrene-butadiene rubber, and a sulfonated styrene/ethylene-butadiene/styrene tri-block polymer.

6. The positive electrode according to claim 1, wherein the mixed amount of the binder and the thickener is 0.5 to 30% by weight based on a total weight of the positive active material, the conductive material, the binder, and the thickener.

7. The positive electrode according to claim 1, wherein the conductive material comprises a carbon powder and a metal powder.

8. The positive electrode according to claim 1, wherein the positive active material is selected from the group consisting of an elemental sulfur (S₈), Li₂Sₙ(n≧1), an organo-sulfur compound, and a carbon-sulfur polymer {(C₂Sₓ)ₙ, wherein x=2.5-50, and n≧2}.

9. A lithium secondary battery comprising:
a positive electrode comprising a positive active material, an electrically conductive material, a binder, and a thickener including a nonionic cellulose-based compound;
a negative electrode comprising a negative active material; and
an electrolyte.

10. The lithium secondary battery according to claim 9, wherein the nonionic cellulose-based compound is a cellulose polymer represented by the following Formula 1: 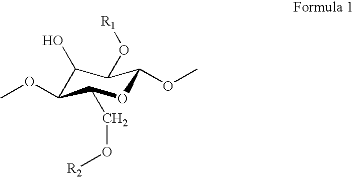
wherein R₁ and R₂ are independently H, a C₁ to C₁₀ alkyl group, or a hydroxy alkyl group.

11. The lithium secondary battery according to claim 9, wherein the nonionic cellulose-based compound is selected from the group consisting of methyl cellulose, hydroxypropyl cellulose, hydroxypropyl methyl cellulose, hydroxyethyl cellulose, and hydroxypropyl ethyl cellulose.

12. The lithium secondary battery according to claim 9, wherein the nonionic cellulose-based compound is added in an amount of approximately 0.1 to 10% by weight based on a total weight of the positive active material, the conductive material, the binder, and the thickener.

13. The lithium secondary battery according to claim 9, wherein the binder is selected from the group consisting of polyvinylidene fluoride, a copolymer of polyvinylidene fluoride and hexafluoropropylene, acrylonitrile-butadiene rubber, styrene-butadiene rubber, and a sulfonated styrene/ethylene-butadiene/styrene tri-block polymer.

14. The lithium secondary battery according to claim 9, wherein the mixed amount of the binder and the thickener is approximately 0.5 to 30% by weight based on a total weight of the positive active material, the conductive material, the binder, and the thickener.
